(19) United States
(12) Patent Application Publication
(10) Pub. No.: US 2026/0236026 A1
(43) Pub. Date: Aug. 13, 2026

(54) ROBOT AND MAP GENERATION METHOD THEREOF

(71) Applicant: SAMSUNG ELECTRONICS CO., LTD., Suwon-si (KR)

(72) Inventors: Jinwon KIM, Suwon-si (KR); Chanho YOON, Suwon-si (KR)

(73) Assignee: SAMSUNG ELECTRONICS CO., LTD., Suwon-si (KR)

(21) Appl. No.: 19/639,674

(22) Filed: Apr. 6, 2026

Related U.S. Application Data
(63) Continuation of application No. PCT/KR2024/019393, filed on Nov. 29, 2024.

(30) Foreign Application Priority Data
Dec. 20, 2023 (KR) 10-2023-0186843

(51) Int. Cl. G05D 1/246; G05D 1/244; G05D 105/80; G05D 109/10; G05D 111/10

(52) U.S. Cl. CPC G05D 1/246; G05D 1/244; G05D 2105/87; G05D 2109/10; G05D 2111/10

(57) ABSTRACT

A robot includes: a plurality of sensors; a driving assembly configured to move the robot; memory storing instructions; and a processor, wherein the instructions, when executed by the processor, cause the robot to: obtain a guide map for guiding map generation and store the guide map in the memory, convert the guide map into a map form recognizable by the robot, identify a search boundary determined based on the map form, and control the driving assembly to move the robot within the search boundary, generate a sensing map of a space, in which the robot moves, based on a sensing value sensed by the plurality of sensors, and match the guide map with the sensing map and generate a space map of the space.

### CROSS-REFERENCE TO RELATED APPLICATIONS

This application is a continuation of International Application No. PCT/KR2024/019393, filed on November 29, 2024, which is based on and claims priority to Korean Patent Application No. 10-2023-0186843, filed on December 20, 2023, in the Japanese Patent Office, the disclosures of which are incorporated by reference herein in their entireties.

### BACKGROUND

1. Field

This disclosure relates to a robot and a map generation method of the robot.

### 2. DESCRIPTION OF RELATED ART

With advancements in robot technologies, an increasing number of robots are used in large spaces such as a factory and a shopping mall. To use such robots in large spaces, the robots require an indoor space map of a large space.

In order to generate an indoor space map of the large space, users need to generate a map as the users move around in the large space together with a robot, and this causes inconvenience to the users. The users need to visit an area that is a target of an indoor space map, and this is a cumbersome procedure.

### SUMMARY

According to an aspect of the disclosure, a robot includes: a plurality of sensors; a driving assembly configured to move the robot; memory storing instructions; and a processor, wherein the instructions, when executed by the processor, cause the robot to: obtain a guide map for guiding map generation and store the guide map in the memory, convert the guide map into a map form recognizable by the robot, identify a search boundary determined based on the map form, and control the driving assembly to move the robot within the search boundary, generate a sensing map of a space, in which the robot moves, based on a sensing value sensed by the plurality of sensors, and match the guide map with the sensing map and generate a space map of the space.

The robot may further include a display, and the instructions, when executed by the processor, may cause the robot to recognize a drawing map drawn by a user on the display as the guide map.

The instructions, when executed by the processor, may cause the robot to: identify, based on an image of a drawing map drawn by a user or a blueprint of the space being captured by a camera among the plurality of sensors, the drawing map or the blueprint from the captured image, and recognize the drawing map or the blueprint as the guide map.

The instructions, when executed by the processor, may cause the robot to: perform a preprocessing task to convert the guide map into the map form recognizable by the robot, decompose each of the guide map converted based on the preprocessing task and the sensing map into a node unit and reconstruct each of the guide map and the sensing map in a graph form, and match nodes in each of the reconstructed graphs based on similarity, and generate the space map.

The instructions, when executed by the processor, may cause the robot to: extract a straight line from each node in the sensing map, extract each convex hull with respect to a vertex of the extracted straight line of each node in the sensing map and a vertex of each node in the guide map, compute a turning function graph of each extracted convex hull, and identify, based on similarity of the computed turning function graph, candidate nodes to be matched mutually in the sensing map and the guide map, and match nodes of high similarity mutually based on scale information, rotation information and translation information of the candidate nodes, and generate the space map.

The robot may further include: a display, and the instructions, when executed by the processor, may cause the robot to: control the display to display a partial map generated at a current position of the robot in the space, in which the robot moves, and generate an updated map based on a drawing added by a user to the partial map displayed on the display, and store the updated map in the memory as the guide map.

The instructions, when executed by the processor, may cause the robot to: determine, based on a sensing value sensed by the plurality of sensors, a movement direction as the robot moves in the space, and estimate, based on the movement direction and the guide map, a point at which the robot is located in the guide map, in real time.

According to an aspect of the disclosure, a map generation method of a robot, includes: obtaining a guide map for guiding map generation and storing the guide map in memory of the robot; converting the guide map into a map form recognizable by the robot; identifying a search boundary determined based on the map form; generating, based on a sensing value of a sensor of the robot, a sensing map of a space in which the robot moves as the robot moves within the search boundary; and matching the guide map with the sensing map and generating a space map of the space.

The obtaining the guide map may include recognizing a drawing map drawn by a user on a display of the robot as the guide map.

The obtaining the guide map may include identifying, based on an image of a drawing map drawn by a user or a blueprint of the space being captured by a camera of the robot, the drawing map or the blueprint from the captured image, and recognizing the drawing map or the blueprint as the guide map.

The generating the space map may include decomposing each of the map form and the sensing map into a node unit and reconstructing the guide map and the sensing map in a graph form, and matching nodes in each of the reconstructed graphs based on similarity.

The generating the space map may further include: extracting a straight line from each node of the sensing map; extracting each convex hull with respect to a vertex of the straight line of each node of the sensing map and a vertex of each node extracted from the guide map; computing a turning function graph of each extracted convex hull; identifying, based on similarity of the computed turning function graph, candidate nodes to be matched mutually in the sensing map and the guide map; and matching nodes of high similarity mutually based on scale information, rotation information and translation information of the candidate nodes.

The obtaining the guide map and storing the guide map may include: displaying, through a display of the robot, a partial map generated at a current position of the robot in the space in which the robot moves; and generating an updated map based on a drawing added by a user to the partial map displayed on the display, and storing the updated map in the memory as the guide map.

The generating the sensing map may further include: determining, based on a sensing value sensed by a plurality of sensors of the robot, a movement direction as the robot moves in the space; and estimating, based on the movement direction and the guide map, a point at which the robot is located in the guide map, in real time.

According to an aspect of the disclosure, a non-transitory computer-readable storage medium storing computer instructions that, when executed by a processor of a robot, cause the robot to perform operations including: obtaining a guide map for guiding map generation and storing the guide map; converting the guide map into a map form recognizable by the robot; identifying a search boundary determined based on the map form; generating, based on a sensing value sensed by a sensor of the robot, a sensing map of a space in which the robot moves as the robot moves within the search boundary; and matching the guide map with the sensing map and generating a space map of the space.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a perspective view illustrating a robot according to one or more embodiments;

FIG. 2 is a block diagram illustrating a configuration of a robot according to one or more embodiments;

FIGS. 3 and 4 are views illustrating a method by which a robot receives an input of a guide map according to one or more embodiments;

FIG. 5 is a view illustrating a method of receiving an input of a guide map by using a partial map for a robot according to one or more embodiments;

FIG. 6 is a view illustrating a process of identifying a search boundary of a robot according to one or more embodiments;

FIG. 7 is a view illustrating a process of matching space maps of a robot according to one or more embodiments;

FIG. 8 is a view illustrating a process of matching graph nodes according to one or more embodiments;

FIG. 9 is an entire view illustrating generation of a space map for a robot according to one or more embodiments; and

FIG. 10 is a flowchart illustrating a method of generating a map for a robot according to one or more embodiments.

### DETAILED DESCRIPTION

General terms currently used as widely as possible are selected as the terms used for the embodiments of the disclosure considering functions in the disclosure, but may be changed based on the intent of those skilled in the art or a judicial precedent, the emergence of a new technology, or the like. In addition, in a specific case, terms arbitrarily chosen by the applicant may be included in the terms used herein. In this case, the meanings of such terms are described in detail in the detailed description of the disclosure. Therefore, the terms used in the disclosure need to be based on the meanings thereof and particulars throughout the disclosure rather than simply the names thereof.

In the disclosure, the expressions “have,” “may have,” “include,” or “may include” and the like indicate the existence of a feature (e.g., a numerical value, a function, an operation or an element such as a part and the like), and do not exclude the existence of an additional feature.

Herein, the expression of “at least one of A or B” is to be understood as indicating any one of “A” or “B” or “A and B”.

The expressions “1^{st},” “2^{nd},” “first,” or “second” and the like used in the disclosure may be used to refer to various elements regardless of their order and/or importance, and may be used merely to differentiate one element from another but not intended to limit the elements.

Based on one element (e.g., a first element) referred to as being “(operatively or communicatively) coupled with/to or connected with/to” another element (e.g., a second element), it is to be understood that one element may be connected to another element directly, or through yet another element (e.g., a third element).

In the disclosure, singular forms include plural forms as well, unless explicitly indicated otherwise. In the disclosure, the term “include” or “comprised of” and the like specify the presence of stated features, numbers, steps, operations, elements, parts or combinations thereof but do not imply the exclusion of the presence or addition of one or more other features, numbers, steps, operations, elements, parts or combinations thereof.

In the disclosure, the term “module” or “unit” may perform at least one function or operation, and be implemented by hardware or software or by a combination of hardware and software. Additionally, a plurality of “modules” or a plurality of “units” may be integrated into at least one module and be implemented by at least one processor excluding a “module” or a “unit” that needs to be implemented by specific hardware.

In the disclosure, the term “user” may refer to a person who uses an electronic apparatus or an apparatus which is used by the person.

Hereinafter, an embodiment of the disclosure is described in greater detail with reference to the accompanying drawings.

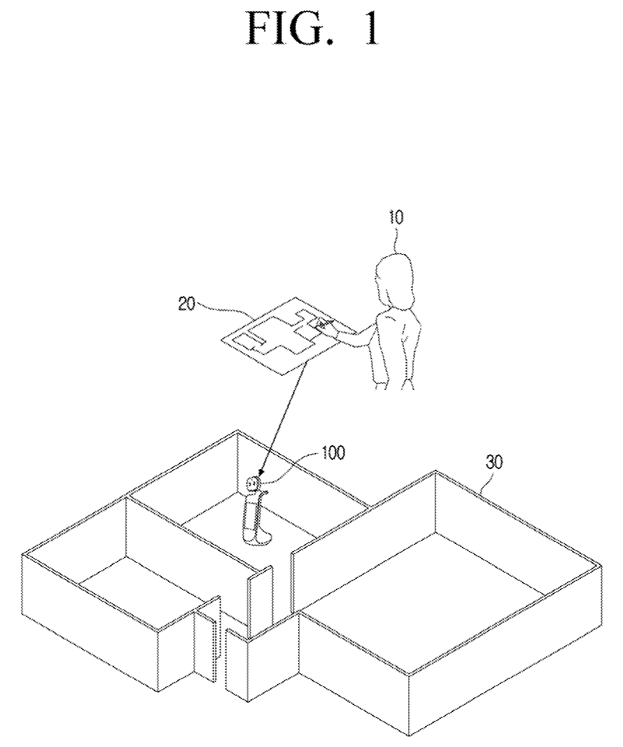

FIG. 1 is a perspective view illustrating a robot according to one or more embodiments. A robot may be an apparatus that is travelable in a state where the apparatus is not driven directly by a person. A robot 100 may be referred to as an autonomous mobile apparatus, an autonomous mobile robot (AMR), an automated guided vehicle (AGV), an unmanned ground vehicle (UGV) and the like in various ways, but in the disclosure, it is described as the robot 100. The robot 100 may be implemented as various types of robots and the like such as a cleaning robot, a serving robot, a mobile projector, an industrial robot, a guide robot, a delivery robot and the like that perform a required task as the robot 10 travels a space, for various purposes.

Referring to FIG. 1, a user 10 may deliver a guide map 20 to the robot 100. The robot 100 may generate a map of a space 30 where the robot 100 is located based on the guide map 20 delivered from the user 10.

The guide map 20 may be a map that is available as initial data for the robot to generate a map. As one example, the guide map 20 may be a map schematically drawn by the user 10 with respect to the space 30 where the robot 100 is located. For example, a map in which a layout is drawn by the user, who knows a schematic structure, a position and a direction of the space, in which the robot is located, may be used as the guide map 20. However, the guide map may not be limited thereto, and a blueprint or a drawing of the space where the robot 100 is located may be used as the guide map 20. A method of inputting the guide map may be implemented in various ways. Detailed descriptions related to this are provided hereafter.

In the disclosure, since the guide map 20 is used to guide initial travel of the robot 100, the guide map 20 may be described as a “guide map”, and may be described as a hand-drawn map, a user map, an initial map, a drawing map, a sketch map and the like in various different ways.

The space 30 refers to the place where the robot 100 is located. The space 30 may include both an outdoor space and an indoor space. For example, the space may be various industrial facilities, office spaces, accommodations, medical facilities, educational facilities, large-scale shopping malls, airports, transportation terminals, laboratories, plants, parks, and the like.

The robot 100 may generate, based on the guide map 20 provided by the user 10, a final map of the space 30 where the robot 100 is located. In the disclosure, a map generated finally is described as a space map.

Referring to FIG. 1, as the user 10 provides a guide map 20 of the space 30 to the robot 100, the robot 100 may identify, based on a plurality of sensing values, a terrain feature and a terrain object and generate a sensing map of the space, as the robot 100 travels the space 30 based on the guide map 20.

When there is no guide map, the robot 100 may ordinarily search all the spaces that may be searched by the robot, i.e., all areas that are traveled using a driving assembly 120 of the robot 100, and since the areas have no wall or no object, may be moved by the robot 100, to generate the sensing map, in the case where the robot 100 travels the space. Accordingly, a resultant map may include areas ranging from areas where the user 10 does not perform a robot-based task to areas where map generation is not required. For example, since the robot 100 obtains all map data of a space and generates a map, large amounts of time may be spent, and further, the generation of a space map generation may not end.

Accordingly, the user 10 may select a space desired by the robot to travel among spaces, draw a guide map 20 of the space, and provide the guide map 20 to the robot 100. When there is a blueprint, the user 10 may mark a desired space only in the blueprint and use the blueprint as a guide map 20. The robot 100 may travel the space specified based on the guide map 20 provided by the user 10 rather than all the spaces, and generate a sensing map using a plurality of sensors.

The robot 100 may match the sensing map that is generated as the robot travels the space with the guide map 20 provided by the user 10 to generate one space map. In the disclosure, the guide map, the sensing map and the space map are described separately. In another example, the guide map may be described as a first map, the sensing map may be described as a second map, and the space map may be described as a third map or a final map.

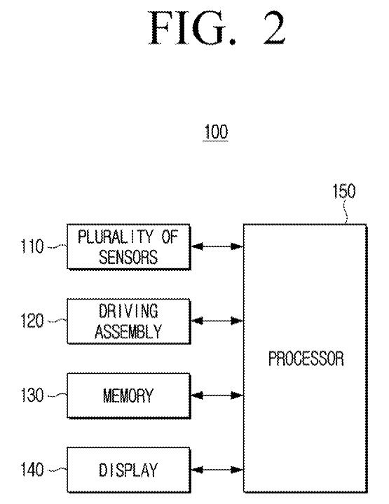

FIG. 2 is a block diagram illustrating a configuration of a robot according to one or more embodiments.

Referring to FIG. 2, the robot 100 may include a plurality of sensors 110, a driving assembly 120, memory 130, a display 140 and a processor 150. However, the robot 100 may not be limited thereto, and may be implemented in the way that part of the elements are excluded or in the way that another element is added. For example, the display 140 may be omitted according to embodiments. According to another embodiment, elements such as various types of input/output interfaces or communication units and the like may be added. An independent drawing of each embodiment is omitted for convenience of description.

The plurality of sensors 110 are sensors for detecting a surrounding environment. For example, the plurality of sensors may include at least one or more of a LiDAR sensor, a vision sensor, an image sensor, an infrared sensor, an ultrasonic sensor, a gyro sensor, an acceleration sensor and a proximity sensor. For example, the plurality of sensors 110 may include at least one or more of a 2D camera, a time-of-flight (TOF) camera, a depth camera, a multi-lens array camera, a stereo vision system, a fused LiDAR camera, and a 3D camera.

As the robot 100 travels a space, the robot 100 may recognize, based on a sensing value sensed by each of the plurality of sensors 110, a surrounding wall, object, pillar, terrain feature, terrain object and the like, and obtain information on depth from the object to identify a distance of the object and the position of the space. The robot 100 may generate, based on the sensing values of the plurality of sensors 110, a sensing map of the space.

The driving assembly 120 may be an element for moving the main body of the robot 100. The driving assembly 120 may include elements such as a plurality of wheels, a driving motor for rotating each of the plurality of wheels, a gear, a shaft and the like. The plurality of wheels may be provided on the lower side or the side surface of the main body of the robot 100 and may support the main body of the robot 100 from the bottom surface of the main body of the robot 100. As the driving motor is operated, a driving force of the driving motor may be transferred to the plurality of wheels, each of the wheels may be rotated, and the robot 100 may be moved based on a frictional force between the bottom surface and the wheels. For example, the driving assembly 120 may adjust the rotation speed or alignment direction of at least one wheel among the plurality of wheels. Instead of the wheels, a continuous track and the like may be used according to the type of robot 100, the weight of a loaded item, the environment where the robot 100 is used.

The memory 130 may store at least one instruction, datum, program and the like required for operations of the robot 100. As one example, the memory 130 may store the guide map provided by the user. The memory 130 may be implemented in the form of memory embedded in the robot 100 or in the form of memory detachable from the robot 100 according to a data storage purpose. For example, in the case of data for driving the robot 100, the data may be stored in the memory embedded in the robot 100, and in the case of data for an extended function of the robot 100, the data may be stored in memory detachable from the robot 100.

The memory embedded in the robot 100 may be implemented as at least one of volatile memory, such as dynamic RAM (DRAM), static RAM (SRAM) or synchronous dynamic RAM (SDRAM), and the like, and non-volatile memory, such as one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash and the like, hard drive, or solid-state drive (SSD).

The memory 130 may be implemented as single memory storing data generated in various operations according to the disclosure, but not limited thereto, and the memory 130 may be implemented to include a plurality of memories respectively storing different types of data or respectively storing data generated in different steps.

The display 140 may be an element for displaying various types of screens. As one example, the user 10 may provide the guide map of a space through the display 140. The display 140 may be implemented as a touch screen coupled with a touch screen, a flexible display, a rollable display, a 3D display, a display in which a plurality of display modules is physically connected, and the like. In the case where at least part of the display 140 is implemented as a touch screen, the user 10 may draw a space on the touch screen to (e.g., directly) to provide the guide map.

The processor 150 may be an element for controlling the operations of the robot 100. The processor 150 may be implemented as a digital signal processor (DSP) processing a digital signal, a microprocessor, or other types of processors. However, the processor is not limited thereto and may include one or more of a central processing unit (CPU), a microcontroller unit (MCU), a micro processing unit (MPU), a controller, an application processor (AP), a communication processor (CP), an ARM processor, an artificial intelligence (AI) processor, or may be defined as such terms. For example, the processor 150 may be implemented in the form of a system on a chip (SoC) with an embedded processing algorithm, large scale integration (LSI), or implemented as a field programmable gate array (FPGA). The processor 150 may execute computer executable instructions stored in the memory 130 to perform various functions.

The processor 150 may be implemented as a single core processor including one core, or one or more multicore processors including a plurality of cores (e.g., a homogeneous multi core or a heterogeneous multi core). In the case where one or more processors 150 are implemented as a multicore processor, each of the plurality of cores included in the multicore processor may include a processor internal memory such as cache memory, and on-chip memory, and common cache shared by the plurality of cores may be included in the multicore processor. For example, each of the plurality of cores (or part of the plurality of cores) included in the multicore processor may read and perform a program instruction for implementing the method according to an embodiment of the disclosure independently, or in the way that all (or part) of the plurality of cores are linked.

The processor 150 may obtain or receive, as an input, the guide map for guiding map generation and store the guide map in the memory 130. The processor 150 may convert the guide map into a map form recognizable by the robot. The processor 150 may identify a search boundary determined by the converted guide map and control the driving assembly 120 such that the driving assembly 120 travels in the search boundary. The processor 150 may generate, based on sensing values that are sensed by the plurality of sensors 110 as the robot 100 travels, sensing map of a space where the robot is located. The processor 150 may match the guide map with the sensing map to generate a space map of the space.

A method by which the processor 150 receives, as an input, the guide map 20 from the user 10 may vary. Hereafter, a method by which the robot 100 receives, as an input, a guide map is described in detail.

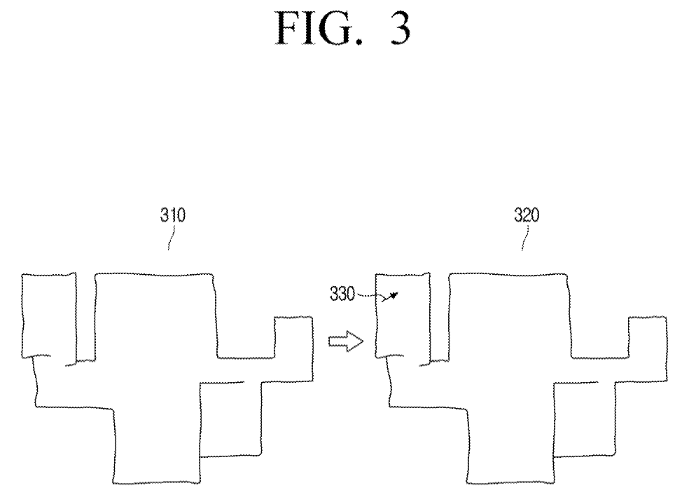

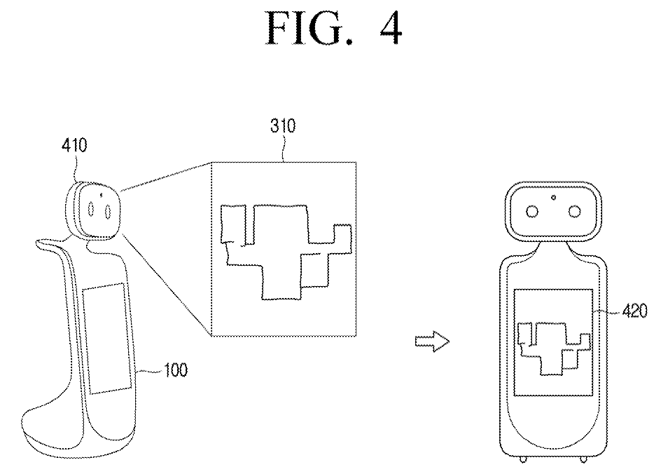

FIGS. 3 and 4 are views illustrating a method by which a robot receives, as an input, a guide map according to one or more embodiments.

Referring to FIG. 3, the user 10 may use, as the guide map, a drawing map schematically drawn on the display 140 by the user directly of the space in which the robot 100 is located. The user 10 may draw a drawing map 310 of the space by visiting the space or based on the user’s experience such as performance of a task and the like.

In the disclosure, “drawing” may include all motion of drawing a line on a display screen directly by the user 10 with a hand or a pen or another object, or the motion of drawing a line as the user 10 moves a cursor in a display screen using an input device (e.g., a mouse, a keyboard, a joystick and the like) connected with the display, and the like.

The user 10 may receive a blueprint or a drawing of a space, and based on the blueprint or the drawing, draw the drawing map 310. For example, the blueprint or drawing of a space is about an initial state of a space, and later, various types of equipment (an apparatus, furniture and other items) may be added. The user 10 may draw the guide map based on a current state of the space while referring to the blueprint or drawing. For example, in the case where the state of a blueprint or drawing of a space obtained by the user 10 is about a state prior to remodeling or repairing of a current space, the user 10 may draw an addition or a change in the space to generate the drawing map 310.

For example, the user 10 may mark 330, on the drawing map 310 drawn by the user, information about the initial position at which the robot 100 is currently located. Referring to FIG. 3, the initial position of the robot 100 is marked with an arrow, but not limited thereto, and any mark may be used as long as the mark is used to identify the position of the robot 100. The user 10 may provide, the robot 100, a drawing map 320 where the initial position of the robot 100 is marked on the drawing map 310 where the space is drawn.

The processor 150 may recognize, based on the drawing maps 310 or 320 drawn by the user 10 as input, the drawing map 310 or 320 as a guide map 20.

As another example, in the case where the robot 100 includes a scanner, a camera and the like, the user 10 may provide, to the robot 100, a map drawn on paper by the user directly, or a blueprint itself that was used at the time of making a space, or a map drawn by the user 10 based on reflecting the position of an object or a changed indoor space additionally on the blueprint, and the like, through the scanner or the camera.

As another example, in the case where the robot 100 is provided with various types of input/output interfaces such as a USB port and the like, the user 10 may connect a USB memory storing data on the guide map 20 drawn by the user to the input/output interfaces, to provide the guide map 20 to the robot 100.

As yet another embodiment, in the case where the robot 100 is provided with a communication interface, the user 10 may draw, based on connecting a terminal device such as a mobile phone or a table PC and the like of the user through the communication unit, a guide map 20 through the screen of the terminal device, and transmit the guide map 20 to the robot 100.

The processor 150 may recognize maps provided in various different ways as a guide map 20, as described above.

FIG. 4 is a view illustrating a method by which a guide map 20 is input using a camera. Referring to FIG. 4, the processor 150 may receive, as an input, the drawing map 310 or 320 provided by the user through a camera 410 among the plurality of sensors 110. In the state where the drawing map 310 or 320 drawn by the user 10 is in front of the camera 410, the user 10 may input a command for capturing an image. The processor 150 may operate the camera 410 and capture an image of the drawing map 310 or 320 according to the command for capturing an image.

In the case where a scanner is included in the plurality of sensors 110, the processor 150 may scan the drawing map through the scanner and may use the scanned drawing map as a guide map 20.

The processor 150 may store the captured image or the scanned image in the memory 130. The processor 150 may display 420 the captured image or the scanned image through the display 140. The processor 150 may analyze the captured image or the scanned image and recognize it as the guide map 20.

For example, the user 10 may bring the blueprint or drawing itself of a space to the camera 410. The processor 150 may capture an image of the blueprint or drawing provided by the user 10 through the camera 410. The processor 150 may identify the captured blueprint or drawing and recognize the blueprint or drawing as a guide map 20.

The processor 150 may capture an image of the drawing map 310 or 320 or the blueprint placed in front of the camera 410 automatically or based on a user manipulation. Specifically, the user 10 may select a guide map input function, through a button of the main body of the robot 100 or a UI screen displayed on the display 140 and the like. For example, the processor 150 may turn on the camera 410 and put the camera 410 into a standby for capturing an image and based on the map being placed in front of the camera 410, capture an image automatically.

The processor 150 may analyze a plurality of image frames in the captured image or scanned image to identify the drawing map or the blueprint provided by the user. For example, the processor 150 may divide entire pixels included in each of the plurality of continuous image frames into a plurality of block units comprised of n*m numbers of pixels. The processor 150 may detect a representative value representing features of pixels in each block. The representative value may be an average pixel value of the pixels in each block. However, embodiments are not limited thereto, and the representative value may be a maximum pixel value or a minimum pixel value, a root mean square (RMS) value.

The processor 150 may connect, among a plurality of blocks, blocks having representative values of a similar range and forming a closed loop disposed at a mutually continuous position, and may identify the closed loop as an edge of an object included in the captured image. The processor 150 may identify the size of the object based on the number of blocks included in the edge. For example, the processor 150 may identify the shape of the object based on the shape of the edge.

For example, the processor 150 may receive, as an input, the guide map 20 through a partial map provided by the robot 100, rather than the drawing map drawn by the user 10 from the beginning or the blueprint. Detailed descriptions in relation to this are provided hereafter.

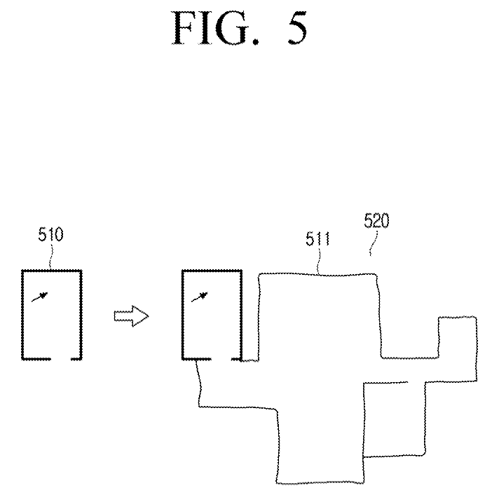

FIG. 5 is a view illustrating a method of receiving an input of a guide map 520 using a partial map for a robot according to one or more embodiments.

The processor 150 may control the display 140 to display a partial map 510 generated at a current position of the robot 100 in the space where the robot 100 is located. In the case where the user 10 makes a drawing additionally with respect to the partial map 510 on the display and generates a map, the processor 150 may recognize the generated map as a guide map 520 and store the generated map in the memory 130. FIG. 5 shows that one guide map 520 including the partial map 510 sensed and generated by the robot 100 and a partial map 511 additionally drawn by the user 10 is generated until the guide map 520 is provided.

In the case where the user 10 draws the guide map 520 directly, it may be difficult to determine a reference space for a drawing in an entire space. Accordingly, the processor 150 may sense a surrounding space where the robot is located through the plurality of sensors 110, and based on the sensed data, generate a schematic partial map 510 of the surrounding space. The partial map means a map generated with respect to a partial space where the robot is located in an entire indoor space. The partial map may be part of an entire map. The partial map, as illustrated in FIG. 5, may be marked with a thick line, flickered, highlighted, or marked in a different color such that the partial map is distinguished from another portion in the entire map.

The processor 150 may display the partial map 510 through the display 140. The user 10 may directly draw the remaining portion 511 additionally following the partial map to generate the drawing map 520, based on the partial map displayed on the display 140. In another example, the user 10 may receive the partial map in a terminal device of the user through a communication unit, a USB, a cable and the like, to add a drawing to the partial map and complete the partial map on the terminal device of the user. The processor 150 may receive, as an input, the drawing map 520 generated as described above and recognize the drawing map as a guide map 20.

The processor 150 may receive, as an input, the guide map 20 through the user or the communication unit in the above-described way.

Then the processor 150 may perform preprocessing of converting the input into a map form recognizable by the robot, using a task of converting the guide map 20 . For example, the preprocessing task may include a series of tasks of linearizing each of the lines in the guide map 20, and connecting the lines mutually and the like.

The drawing map provided by the user 10 may include a curved line rather than a straight line, and a broken straight line. For example, a line for displaying a flat wall may be displayed in the way that the line is bent like a curved line rather than a straight line, or in the way that a corner at which a line and a line meet is not at the right angle, or in the way that one line is displayed as two lines or a line painted over. For example, the processor 150 may have difficulty in determining an outermost boundary in the guide map 20, and generating sensing map based on the guide map 20.

The processor 150 may convert the input guide map 20 into a map form comprised of rectilinear lines through the preprocessing task. For example, the processor 150 may analyze the guide map 20 to obtain coordinate values (e.g., x and y coordinates) of the positions of pixels constituting each of the lines included in the guide map 20. The y coordinate values of a plurality of pixels constituting one horizontal line are the same, while the x coordinate values of a plurality of pixels constituting one vertical line are the same. The x coordinate values of a plurality of pixel values constituting a line that is continued and bent in a horizontal direction may be constantly increased or decreased while the y coordinate values thereof are changed, and the y coordinate values of a plurality of pixels constituting a line that is continued and bent in a vertical direction are constantly increased or decreased while the x coordinate values thereof are changed.

Accordingly, the processor 150 may compare the x and y coordinate values of a plurality of pixels constituting one line to modify the x coordinate values or the y coordinate values of a small number of pixels based on the coordinate values of a large number of pixels. Accordingly, a curved line or a crooked line may be modified to a straight line. In the case where two lines are spaced from each other within a predetermined distance, the processor 150 may extend, based on the directionality of each of the two lines, at least one of the two lines to connect the two lines mutually.

For example, a curved wall surface or a curved object may be present according to a spatial structure. For example, the user 10 may draw a curved line on the guide map 20. However, in the case where the user makes a drawing directly, the curvature of the curved line may be illustrated in a constant manner. The processor 150 may compare the x and y coordinates of pixels continued in succession to calculate a curvature and based on the curvature being greater than or equal to a predetermined curvature, may determine that the user draws the curved line. Accordingly, the processor may identify the relative curvatures of the coordinate values of entire pixels included in the line to identify a plurality of curvatures, and based on the identified curvatures, modify the coordinate values of some of the pixels. Thus, a line of a constant curvature may be illustrated.

The processor 150 may convert the guide map based on the above-described preprocessing task and store the converted guide map in the memory 130.

The processor 150 may identify, based on the converted guide map, a search boundary on which the robot 100 may travel. The processor 150 may generate a sensing map based on the identified search boundary. Detailed descriptions in relation to this are provided hereafter.

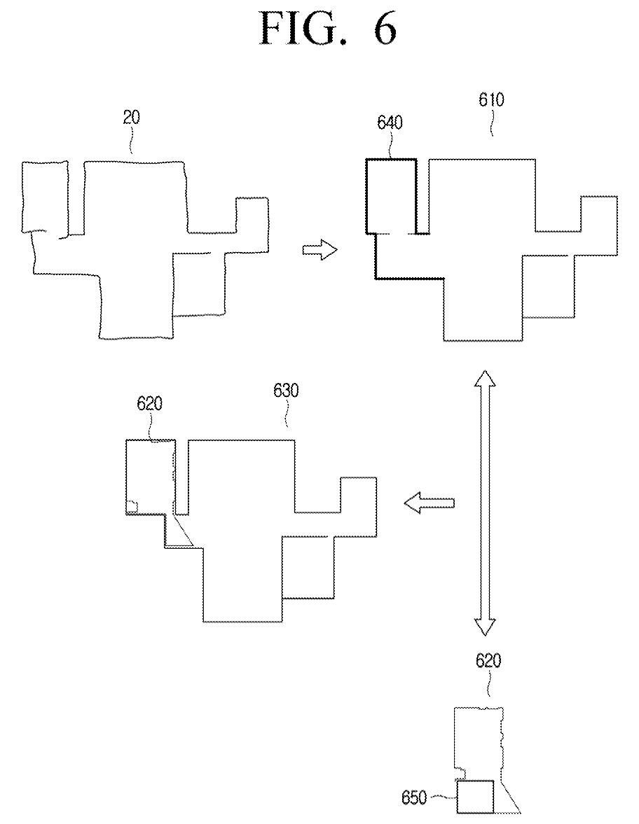

FIG. 6 is a view illustrating a process of identifying a search boundary of a robot according to one or more embodiments.

The robot 100 may convert, based on a guide map 20 being input, the guide map 20 based on the above preprocessing task, and search a surrounding space based on the converted guide map 610. The robot 100 may search the surrounding space using a plurality of sensors 110 and generate a sensing map. For example, the robot 100 may generate the sensing map 620 using simultaneous localization and mapping (SLAM) and estimate the position of the robot. SLAM means a technology for simultaneous localization and mapping, and a technology in which a mobile object such as a robot estimates the position of the object and simultaneously generates a map of a surrounding environment. The SLAM technology may enable generation of a map automatically during an autonomous search of a space even in an environment where GPS signals are limited or a network is not available.

The robot 100 may collect information on a surrounding environment using a LiDAR sensor, a depth camera and the like among the plurality of sensors 110. The robot 100 may extract a feature such as a pillar, an edge, an object and the like in the surrounding environment from the data sensed by the plurality of sensors. The robot 100 may estimate a current position and a pose using the sensing data and the extracted feature. For example, the processor 150 may recognize, based on a sensing value of a geomagnetic sensor and the like, a direction faced by the front of the robot 100. For example, the processor 150 may compute, based on a distance from a wall surface sensed in the East, West, South, and North directions respectively using the plurality of sensors 110, a current position in a space. For example, in the case where various types of surrounding objects are sensed in addition to the wall surface, the processor may compare a distance up to the objects and a distance up to the wall surface behind the objects, to estimate the sizes of the objects.

The robot 100 may use the sensing data sensed by the plurality of sensors and the feature of the surrounding environment to generate a map of the space.

The robot 100 may generate a sensing map 620 of a specific space as the robot 100 travels a space. For example, the sensing map means a map that is generated by the robot with the plurality of sensors as the robot travels a space. The sensing map may not be limited thereto, and may be referred to as a travel map, a SLAM map, a robot map and the like in various different ways, but in the disclosure, is collectively referred to as a sensing map.

When there is no guide map, the robot 100 may search all spaces basically to generate the sensing map. The sensing map 620 of FIG. 6 may indicate a sensing map 620 sensed without the guide map 610 in a specific space 640 out of a space.

As illustrated in FIG. 6, as a result of comparing the specific space 640 of the converted guide map 610 with the sensing map 620 generated by the robot 100, a partial space 650 may be added in the sensing map 620. For example, since the robot 100 searches all spaces where the robot is movable through a driving assembly 120 when there is no guide map, a portion 650 not included in the guide map 610 may be included in the sensing map 620.

The portion 650 may be a space requiring no task of the robot, and a space desired by the user not to search.

Since the robot 100 in the disclosure generates the sensing map 620 based on the guide map 610, the robot may obtain the sensing map 620 including the specific space 640 in the way that the portion 650 is excluded. According to the use of the guide map 610, there may be a difference corresponding to the partial portion 650.

The robot 100, as described above, may determine a search boundary 630 searchable based on the converted guide map 610. The search boundary means a boundary that is searchable as the robot travels a space. The searchable boundary may be arbitrarily selected by the user and determined through the guide map 610, or an area too dangerous for the robot to travel or an area requiring no task may be set and determined as the search boundary. For example, in the case a serious accident is likely to occur when the robot travels a partial space with a cliff or a high step out of a space, the user 10 may generate a guide map 610 without the area at a time of providing the guide map 610.

The processor 150 may match the converted guide map 610 with the sensing map 620 generated in real time as the robot 100 travels, to determine the search boundary 630 searchable by the robot 100. As described with reference to FIG. 5, the user 10 may be provided from the robot 100 with the partial map, in which a current position of the robot 100 is marked. The user 10 may provide, to the robot 100, the guide map 610 in which a space is additionally drawn on the provided partial map. Accordingly, since the robot 100 identifies, based on the partial map, the current position of the robot 100 on the converted guide map 610, and identifies the current position of the robot 100 on the sensing map 620, the robot 100 may compare the current position of the robot on the converted guide map 610 with the current position of the robot 100 on the sensing map 620 in the specific space 640 out of the space and match the converted guide map 610 with the sensing map 620.

However, since the position marked by the user 10 is not an accurate current position, the processor 150 may estimate the position of the robot 100 primarily based on the converted guide map 610, and then modify the position based on a sensing value obtained during travel.

The processor 150 may match the converted guide map 610 with the sensing map 620 in real time, to determine a search boundary 630. Accordingly, the robot 100 may travel and generate a map only in the determined search boundary. The robot 100 may perform a search only in the search boundary 630 although there is an area that is actually further searchable by the robot 100, and in the case where the sensing map 620 is completed in the search boundary, a further search may no longer be performed.

The processor 150 may generate a sensing map 620 of a space based on the determined search boundary. For the processor 150 to match the generated sensing map 620 with the guide map 610 and generate one space map, a process of matching the two maps may be required. Detailed descriptions in relation to this are provided hereafter.

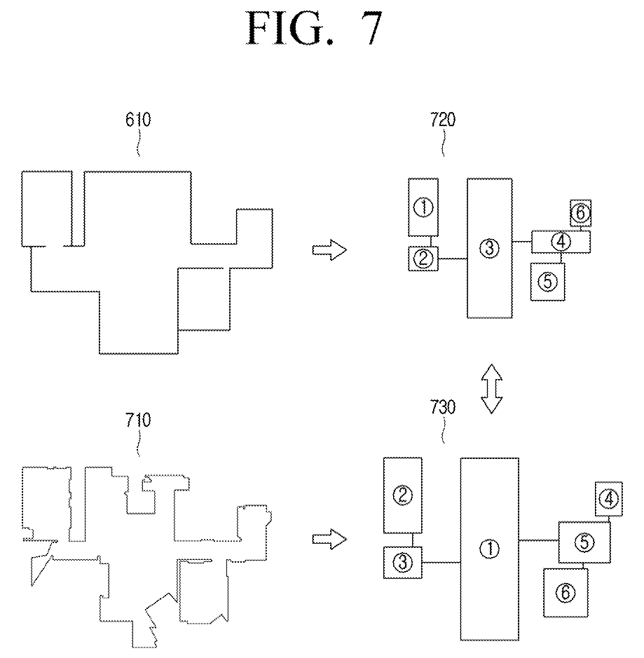

FIG. 7 is a view illustrating a process of matching space maps of a robot according to one or more embodiments.

The processor 150 may decompose each of the guide map 610 converted based on a preprocessing task and the sensing map 710 into node units and reconstruct the guide map 610 and the sensing map 710 in a graph form. The processor 150 may match nodes in each of the reconstructed graphs based on similarity, and generate a space map.

The processor 150 may generate a sensing map 710 of a space based on the search boundary 630. The processor 150 may decompose each of the converted guide map 610 and the sensing map 710 into node units. The processor 150 may generate one space map based on matching between each of the decomposed nodes and each of the decomposed nodes.

The processor 150 may decompose the converted guide map 610 into node units, and reconstruct the converted guide map 610 into a graph form in which each node is connected, to generate a guide map graph 720.

For example, the processor 150 may decompose the sensing map 710 into node units, and reconstruct the sensing map 710 in a graph form in which each node is connected, to generate a sensing map graph 730.

In a SLAM-based position estimation method, the node may be an element differentiating a specific position or a landmark or a specific point of a certain environment in the graph. FIG. 7 shows that each of the partial spaces constituting an entire space is expressed as a node, and shows a graph in which each node is connected in a line.

The processor 150 may decompose the nodes based on the shape of each area in a map. Typically, one independent space (e.g., a plant) may be comprised of various partial spaces (a work space, a material room, a rest room and the like). Each of the partial spaces may be connected through a passage or connected directly through a door, and differentiated from another space by a wall, a door, or the like. The processor 150 may decompose each differentiated partial space as a node for decomposition.

Referring to FIG. 7, the guide map graph 720 and the sensing map graph 730 are decomposed into node units, and each node may be numbered from 1 to 6. In the case of a guide map graph 720, each node is numbered left to right from 1 to 6. For example, in the case of a sensing map graph 730, each node is numbered left to right from 1 to 6 with respect to the largest node at the center. The numbering of each node may be arbitrarily, and although the guide map graph 720 and the sensing map graph 730 are at the same position, the nodes may be numbered with a different number. However, numbering is not limited thereto, and an identical number may be given to the nodes based on their positions.

For example, there may be a difference in the sizes of the guide map graph 720 and the sensing map graph 730. There may be a difference in the scales and the horizontal/vertical ratios of the guide map where an actual space is schematically drawn, and the sensing map 730 which is generated by the robot. Accordingly, a difference in the scale may be made even in an identical space based on a result of comparing node 1 of the guide map graph 720 with node 2 of the sensing map graph 730. For example, the horizontal, vertical ratios may differ even in an identical space based on a result of comparing node 4 of the guide map graph 720 with node 5 of the sensing map graph 730.

The processor 150 may generate the sensing map 730 based on the guide map, and generate a node unit-based graph in real time. The robot 100 may end a search, based on mapping being completed with respect to all the nodes of the sensing map 730 in the determined search boundary.

The processor 150 may extract the nodes from each of the graphs comprised of the node units. The processor 150 may compare the similarity of the extracted nodes to match the two graphs. Hereafter, a method of comparing the similarity of the nodes extracted from each of the graphs is described in detail.

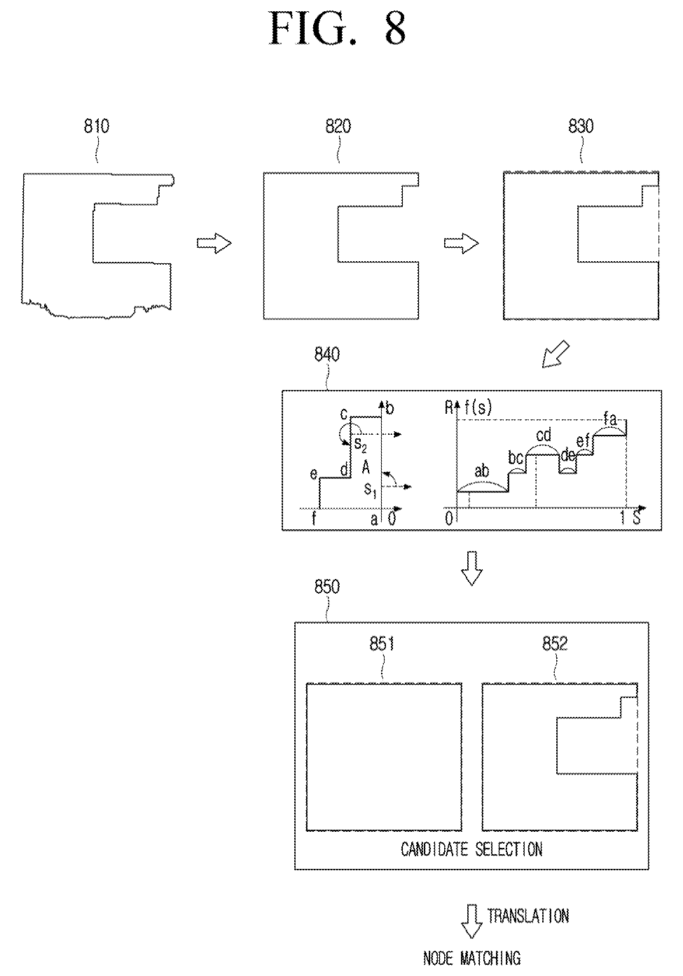

FIG. 8 is a view illustrating a process of matching graph nodes according to one or more embodiments.

The processor 150 may extract a straight line from each of the extracted nodes of the sensing map 730. The processor 150 may extract each convex hull with respect to a vertex of the straight line of each of the extracted nodes of the sensing map 730 and a vertex of each of the nodes extracted from the guide map. The processor 150 may compute a turning function graph for each extracted convex hull, and based on similarity of the computed turning function graph, identify candidate nodes to be matched mutually in the sensing map 730 and the guide map. The processor 150 may match, based on scale information, rotation information with translation information of the candidate nodes, nodes of high similarity mutually and generate a space map.

Referring to FIG. 8, the processor 150 may extract 820 a Hough line corresponding to a straight line at node 2 (810) of the sensing map graph 730. The processor 150 may extract 830 the convex hull with respect to vertices of extracted lines. The convex hull means at least a convex polygon surrounded by a set of points.

The reason for extracting a convex hull from a specific node of the sensing map 730 is that when the robot 100 generates the sensing map 730 as the robot 100 travels a rectangular specific space, the robot 100 generates a “⊏”-shaped sensing map 730, as shown in 810, in the case where an object is located in the specific space. However, in the case of a guide map such as a drawing map drawn by the user and a blueprint, the guide map may be generated as a rectangle-shaped space excluding various types of objects in the space. Then the “⊏”-shaped sensing map 730 and the rectangle-shaped guide map may hardly be compared. Accordingly, the processor 150 may extract a convex hull at a specific node of the sensing map graph considering the objects in the space, and compare the extracted convex hull of the specific node with the node of the guide map graph to match the nodes.

The processor 150 may extract a convex hull even at each node of the guide map graph. The processor 150 may compute a turning function graph 840 for each of the convex hulls extracted from each graph.

The turning function means representing convex hulls in a graph form, considering all the length, angle and direction of each straight line of a specific node. The x axis of the turning function means a length, while the y axis thereof means an angle.

In the case where a specific node is expressed as a turning function, the processor 150 may perform a process of normalizing an entire length as a value within a specific range. For example, the y-axis value of the turning function graph may be increased based on a rotation being made by 90 degrees counterclockwise and decreased based on a rotation being made by 90 degrees clockwise, with respect to any one point of the specific node. Accordingly, the processor 150 may obtain scale and rotation information of each node through the turning function graph. The processor 150 may identify, based on the scale and rotation information obtained through the turning function graph, a candidate node to be matched.

The processor 150 may select, based on the turning function graph, node 1 (851) of the nodes of the guide map graph and node 2 (852) of the nodes of the sensing map graph as candidate nodes 850. The processor 150 may determine translation information having a minimum error value between the selected candidate nodes. The translation information may mean a position moving distance between two coordinates, and a distance between two coordinates.

The processor 150 may extract the pixel coordinate of a pixel unit from the selected candidate nodes. The processor 150 may obtain a distance of each pixel from the pixel coordinates of the sensing map graph and the pixel coordinates of the guide map graph and add the distances of all the pixels and then determine a minimum value as the translation information. As a distance with respect to a pixel coordinate at each node becomes a minimum, a difference in the distances with respect to the two candidate nodes becomes a minimum, and as a result, it may be determined that the error value becomes a minimum. Accordingly, the processor 150 may determine, based on the translation information, similarity between the candidate nodes, and match nodes of high similarity mutually to generate a space map.

Accordingly, the processor 150 may determine similarity based on the scale information, rotation information and translation information of the nodes of each of the graphs of the two maps, and match nodes of high similarity to generate a space map.

For example, the processor 150 may determine a travel direction based on a sensing value sensed from the plurality of sensors 110 as the robot 100 travels a space. The processor 150 may estimate, based on the travel direction and the guide map, a point at which the robot is located in the guide map, in real time.

For example, in the case where the robot 100 travels a space based on the plurality of sensors 110, the robot 100 may determine the travel direction such as the left direction, the right direction and the forward direction. In the case where the robot 100 can move only in the right direction or the forward direction when the robot moves from a specific space to another, the robot 100 may estimate, from the guide map input, an area where the robot cannot move in the left direction as a point where the robot is located. As another example, in the case where the robot can move only in the left direction, the robot may estimate, from the guide map input, an area where there is a path on which the robot can move only in the left direction as a point where the robot is located.

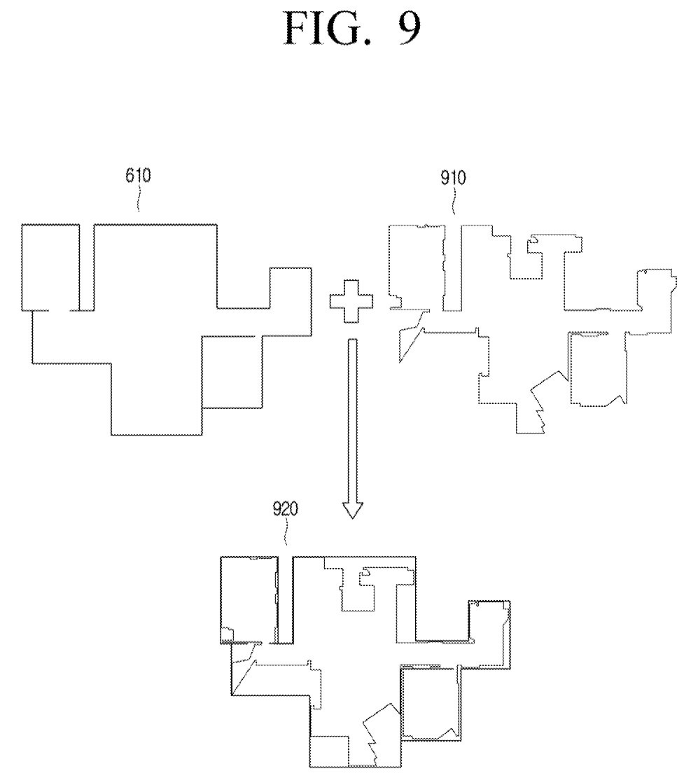

FIG. 9 is an entire view illustrating generation of a space map for a robot according to at least one embodiment.

In the case where the processor 150 receives no guide map as input, the processor 150 may generate an entire sensing map 910 for an entire space. However, in the case where the processor 150 receives, as an input, the guide map 610 drawn by the user, the processor may generate, based on the determined search boundary, a sensing map 910. The processor 150 may match the guide map 610 and the sensing map 910 to generate a space map 920 finally. The space map means a map that is generated finally for the robot 100 to travel a space based on a condition set by the user. Accordingly, the robot 100 may travel the space based on the space map 920.

The processor 150 may extract nodes from each of a guide map graph and a sensing map graph and compare and match each of the nodes. The processor 150 may match each of the nodes to generate one space map 920. The space map 920 may be a map that is generated such that similar nodes are matched mutually and overlapped into one among the nodes extracted from the guide map 610 and the sensing map 910. The robot 100 may travel only within a range set by the user through the space map 920. Accordingly, the robot 100 may perform a task or provide a service as the robot 100 travels a space based on the space map 920.

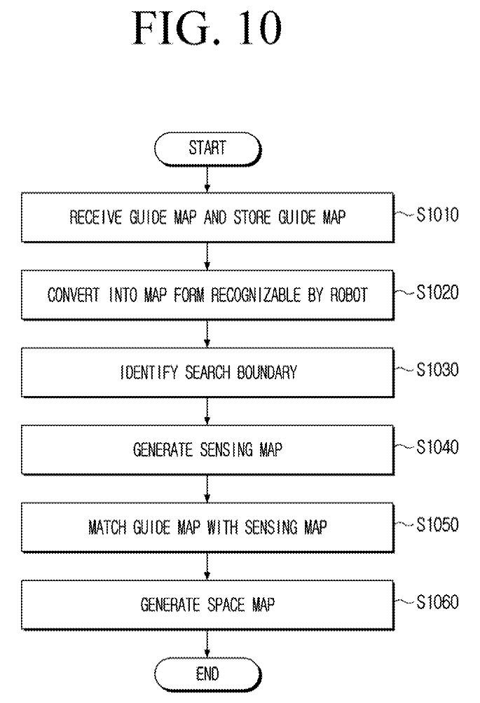

FIG. 10 is a flowchart illustrating a method of generating a map for a robot according to one or more embodiments.

Referring to FIG. 10, the robot 100 may obtain receive, as an input, a guide map for guiding map generation and stores the guide map (S1010). The robot 100 may convert the guide map into a map form that is recognizable by the robot 100 (S1020). The robot 100 may identify a search boundary determined based on the converted guide map (S1030). The robot 100 may generate a sensing map with respect to a space where the robot 100 is located based on a sensing value sensed by a plurality of sensors as the robot 100 travels within the search boundary (S1040). The robot 100 may match the guide map with the sensing map (S1050) and may generate a space map with respect to the space (S1060).

The method of generating the guide map for guiding map generation and the sensing map, and the method of matching the guide map with the sensing map to generate the space map are described in detail with reference to the above-described embodiments, and accordingly, repetitive descriptions of the methods are omitted.

The control method described with reference to FIG. 10 may be performed by the robot 100 having the above elements of FIG. 2, but may not be limited thereto, and may be performed by a robot 100 having various elements.

Each of the above-described embodiments may be implemented solely, or may be combined with at least one of the embodiments partially or entirely and implemented together in one device.

According to the above-described embodiments, the robot 100 may receive, as an input, the guide map for guiding map generation such that a space map may be generated accurately and efficiently, while the user may not need to visit a space and generate a map together with the robot 100.

For example, the above-described embodiments may be solely applied to a product, but at least part of the particulars of an embodiment may be combined with another embodiment of the disclosure and implemented together.

The above-described embodiments may be implemented with software including instructions stored in a storage medium readable by a machine (e.g., a computer). The machine, as a device capable of calling the stored instructions from the storage media and operating according to the called instructions, may include an electronic apparatus (e.g., a robot 100) according to the disclosed embodiments. Based on the instructions executed by a processor, the processor may perform functions corresponding to the instructions directly or using other elements under the control of the processor. The instructions may include a code generated or executed by a compiler or an interpreter. The machine-readable storage medium may be provided in the form of a non-transitory computer readable storage medium. For example, the term “non-transitory” only means that the storage medium includes no signal and is tangible, while the term does not distinguish semi-permanent or temporary storage of data in the storage medium.

For example, the methods according to the above-described embodiments may be provided in a computer program product.

For example, a non-transitory readable storage medium or a computer program product storing computer instructions for performing operations may be provided, the operations including receiving, as an input, a guide map for guiding map generation and storing the guide map, converting the guide map into a map form recognizable by the robot 100, identifying a search boundary determined based on the converted guide map, generating, based on a sensing value sensed by a plurality of sensors provided to the robot, a sensing map of a space in which the robot 100 is located as the robot travels within the search boundary, and matching the guide map with the sensing map and generating a space map of the space.

The computer program product may be distributed in the form of a machine-readable storage medium (e.g., compact disc read only memory (CD-ROM)), or distributed online through an application store (e.g., Play Store^{TM}). In the case of an online distribution, at least part of the computer program product (e.g., a downloadable app) may be stored at least temporarily, or generated temporarily in a storage medium such as a server of a manufacturer, a server of an application store, or memory of a relay server.

Further, computer instructions or programs for performing a map generation method and the like of a robot 100 according to the above-described embodiments may be stored in a non-transitory computer-readable medium. The computer instructions stored in such a non-transitory computer-readable medium, when executed by the processor of a specific device, causes the specific device to perform processing operations in a device according to the above-described embodiments. The non-transitory computer-readable medium means a medium that stores data semi-permanently and is readable by a machine, rather than a medium such as a register, cache, memory and the like that store data temporarily. Specific examples of the non-transitory computer-readable medium may include a CD, a DVD, a hard disc, a blue-ray disc, a USB, a memory card, ROM and the like.

While example embodiments of the present disclosure are illustrated and described above, embodiments are not limited to the above-described embodiments, and certainly, various modifications thereof may be made by those skilled in the art to which the present disclosure pertains, without departing from the matter of the disclosure claimed in the section of claims, and are not to be understood as separating from the technical spirit or prospect of the disclosure.

What is claimed is:

1. A robot comprising:
a plurality of sensors;
a driving assembly configured to move the robot;
memory storing instructions; and
a processor,
wherein the instructions, when executed by the processor, cause the robot to:
obtain a guide map for guiding map generation and store the guide map in the memory,
convert the guide map into a map form recognizable by the robot,
identify a search boundary determined based on the map form, and control the driving assembly to move the robot within the search boundary,
generate a sensing map of a space, in which the robot moves, based on a sensing value sensed by the plurality of sensors, and
match the guide map with the sensing map and generate a space map of the space.

2. The robot of claim 1 further comprising:
a display,
wherein the instructions, when executed by the processor, cause the robot to recognize a drawing map drawn by a user on the display as the guide map.

3. The robot of claim 1, wherein the instructions, when executed by the processor, cause the robot to:
identify, based on an image of a drawing map drawn by a user or a blueprint of the space being captured by a camera among the plurality of sensors, the drawing map or the blueprint from the captured image, and
recognize the drawing map or the blueprint as the guide map.

4. The robot of claim 1, wherein the instructions, when executed by the processor, cause the robot to:
perform a preprocessing task to convert the guide map into the map form recognizable by the robot,
decompose each of the guide map converted based on the preprocessing task and the sensing map into a node unit and reconstruct each of the guide map and the sensing map in a graph form, and
match nodes in each of the reconstructed graphs based on similarity, and generate the space map.

5. The robot of claim 4, wherein the instructions, when executed by the processor, cause the robot to:
extract a straight line from each node in the sensing map,
extract each convex hull with respect to a vertex of the extracted straight line of each node in the sensing map and a vertex of each node in the guide map,
compute a turning function graph of each extracted convex hull, and identify, based on similarity of the computed turning function graph, candidate nodes to be matched mutually in the sensing map and the guide map, and
match nodes of high similarity mutually based on scale information, rotation information and translation information of the candidate nodes, and generate the space map.

6. The robot of claim 1 further comprising:
a display,
wherein the instructions, when executed by the processor, cause the robot to:
control the display to display a partial map generated at a current position of the robot in the space, in which the robot moves, and
generate an updated map based on a drawing added by a user to the partial map displayed on the display, and store the updated map in the memory as the guide map.

7. The robot of claim 1, wherein the instructions, when executed by the processor, cause the robot to:
determine, based on a sensing value sensed by the plurality of sensors, a movement direction as the robot moves in the space, and
estimate, based on the movement direction and the guide map, a point at which the robot is located in the guide map, in real time.

8. A map generation method of a robot, the map generation method comprising:
obtaining a guide map for guiding map generation and storing the guide map in memory of the robot;
converting the guide map into a map form recognizable by the robot;
identifying a search boundary determined based on the map form;
generating, based on a sensing value of a sensor of the robot, a sensing map of a space in which the robot moves as the robot moves within the search boundary; and
matching the guide map with the sensing map and generating a space map of the space.

9. The map generation method of claim 8, wherein the obtaining the guide map comprises recognizing a drawing map drawn by a user on a display of the robot as the guide map.

10. The map generation method of claim 8, wherein the obtaining the guide map comprises identifying, based on an image of a drawing map drawn by a user or a blueprint of the space being captured by a camera of the robot, the drawing map or the blueprint from the captured image, and recognizing the drawing map or the blueprint as the guide map.

11. The map generation method of claim 8, wherein the generating the space map comprises decomposing each of the map form and the sensing map into a node unit and reconstructing the guide map and the sensing map in a graph form, and
matching nodes in each of the reconstructed graphs based on similarity.

12. The map generation method of claim 11, wherein the generating the space map further comprises:
extracting a straight line from each node of the sensing map;
extracting each convex hull with respect to a vertex of the straight line of each node of the sensing map and a vertex of each node extracted from the guide map;
computing a turning function graph of each extracted convex hull;
identifying, based on similarity of the computed turning function graph, candidate nodes to be matched mutually in the sensing map and the guide map; and
matching nodes of high similarity mutually based on scale information, rotation information and translation information of the candidate nodes.

13. The map generation method of claim 8, wherein the obtaining the guide map and storing the guide map comprises:
displaying, through a display of the robot, a partial map generated at a current position of the robot in the space in which the robot moves; and
generating an updated map based on a drawing added by a user to the partial map displayed on the display, and storing the updated map in the memory as the guide map.

14. The map generation method of claim 8, wherein the generating the sensing map further comprising:
determining, based on a sensing value sensed by a plurality of sensors of the robot, a movement direction as the robot moves in the space; and
estimating, based on the movement direction and the guide map, a point at which the robot is located in the guide map, in real time.

15. A non-transitory computer-readable storage medium storing computer instructions that, when executed by a processor of a robot, cause the robot to perform operations, the operations comprising:
obtaining a guide map for guiding map generation and storing the guide map;
converting the guide map into a map form recognizable by the robot;
identifying a search boundary determined based on the map form;
generating, based on a sensing value sensed by a sensor of the robot, a sensing map of a space in which the robot moves as the robot moves within the search boundary; and
matching the guide map with the sensing map and generating a space map of the space.

16. The non-transitory computer-readable storage medium of claim 15, wherein the obtaining the guide map comprises recognizing a drawing map drawn by a user on a display of the robot as the guide map.

17. The non-transitory computer-readable storage medium of claim 15, wherein the obtaining the guide map comprises identifying, based on an image of a drawing map drawn by a user or a blueprint of the space being captured by a camera of the robot, the drawing map or the blueprint from the captured image, and recognizing the drawing map or the blueprint as the guide map.

18. The non-transitory computer-readable storage medium of claim 15, wherein the generating the space map comprises:
decomposing each of the map form and the sensing map into a node unit and reconstructing the guide map and the sensing map in a graph form; and
matching nodes in each of the reconstructed graphs based on similarity.

19. The non-transitory computer-readable storage medium of claim 18, wherein the generating the space map further comprises:
extracting a straight line from each node of the sensing map;
extracting each convex hull with respect to a vertex of the straight line of each node of the sensing map and a vertex of each node extracted from the guide map;
computing a turning function graph of each extracted convex hull;
identifying, based on similarity of the computed turning function graph, candidate nodes to be matched mutually in the sensing map and the guide map; and
matching nodes of high similarity mutually based on scale information, rotation information and translation information of the candidate nodes.

20. The non-transitory computer-readable storage medium of claim 15, wherein the obtaining the guide map and storing the guide map comprises:
displaying, through a display of the robot, a partial map generated at a current position of the robot in the space in which the robot moves; and
generating an updated map based on a drawing added by a user to the partial map displayed on the display, and storing the updated map in the memory as the guide map.
